(19) United States
(12) Patent Application Publication
(10) Pub. No.: US 2016/0321636 A1
(43) Pub. Date: Nov. 3, 2016

(54) RECEIVING CARD-PRESENT PAYMENTS FOR E-COMMERCE ORDERS ON BEHALF OF MERCHANTS

(71) Applicant: SwipeOut, Inc., Cambridge, MA (US)

(72) Inventors: Ming-Tai Huh, Cambridge, MA (US); Uzoma Orji, Cambridge, MA (US)

(21) Appl. No.: 15/089,981

(22) Filed: Apr. 4, 2016

Related U.S. Application Data
(60) Provisional application No. 62/155,620, filed on May 1, 2015.

(51) Int. Cl. G06Q 20/20; G06Q 20/38; G06Q 20/32

(52) U.S. Cl. CPC G06Q 20/204; G06Q 20/322; G06Q 20/38

(57) ABSTRACT

Methods and apparatus for receiving card-present payments for e-commerce orders on behalf of merchants. A method includes, in a network comprising at least a mobile device, a merchant's server, a merchant's payment processor and a third party server, the mobile device including a merchant's mobile app, the merchant's mobile app including a third party integrated software development kit (SDK), the mobile device linked to a card reader, accepting card-present payment using the third party SDK provided by a third-party partner within merchant's mobile app.

### CROSS-REFERENCE TO RELATED APPLICATIONS

This application claims priority to U.S. Provisional Application No. 62/155,620, filed on May 1, 2015. The disclosure of the prior application is considered part of and is incorporated by reference in the disclosure of this application.

### BACKGROUND OF THE INVENTION

The present invention generally relates to e-commerce, and more specifically to receiving card-present payments for e-commerce orders on behalf of merchants.

Currently, e-commerce orders can only be paid using the primary account number on the customer's credit or debit card. This card-not-present method requires the customer to manually enter the account number on a form on the merchant's website. Merchants have expedited this process by securely storing the card number on their servers and allowing properly authenticated customers to access their sensitive data. This method reduces the friction for the customer but increases the merchant's security requirements to properly receive credit card data on their servers and to comply with the Payment Card Industry Data Security Standard (PCI DSS) guidelines for storing the data.

The current credit card fee structure charges the merchant a higher rate for card-not-present payment than card-present as the risk of fraud is higher. Research has shown that fraud in card-present settings (brick-and-mortar) has been reduced especially where chip and pin is accepted. Conversely, a CyberSource® 2013 report states that fraud order rate has gone up from 0.6% to 0.8%—a 33% increase year over year. Moreover, such fraud carries a large financial penalty. the LexisNexis® 2014 True Cost of Fraud^{SM} 2014 Mobile Study report states that the merchant suffers 3.08 per1 of fraud due to chargebacks, fines, re-stocking fees, and so forth. Therefore, the pressing issues for the merchant are the following:

1. How can I reduce my PCI scope and liability in accepting credit card payment for e-commerce?

2. How can I receive card-present rates like brick-and-mortar stores for e-commerce?

Merchant aggregators, such as Braintree and Stripe, can accept credit card payments on behalf of a merchant to eliminate PCI compliance requirements. Credit card information is sent directly to the aggregator and an authorization response is sent back to the merchant with transaction details. This method addresses Issue 1 listed above but this method simply acts as an intermediary to accept the manually-entered credit card data. The payment information is still classified as card-not-present and moreover, these aggregators use their own payment processor.

For some small merchants who want to accept credit cards online quickly in the most cost-effective way, then the merchant aggregator is a viable option. For large merchants, the time and effort they spent to receive the preferred rates they negotiated from their own payment processor would be all for naught if they chose an aggregator. At the scale of a large merchant, the pricing offered by these third party aggregators companies would be considerably more expensive.

Another alternative for merchants could be to use tokenization services offered by some payment processors. The credit card information is sent directly to the processor and unique one-to-one token is returned that the merchant could store on its servers. The merchant would no longer be in PCI scope and still allow the customer to use a saved credit card to pay for orders for a seamless user experience. Unfortunately, these credentials are still classified as card-not-present.

U.S. Pat. No. 7,810,729 to Morley, Jr. (2010) describes a card reader device that can transmit the track data stored on the magnetic stripe of a credit to a mobile device via the audio jack. U.S. Pat. No. 8,281,998 to Tang et al (2011) and U.S. Pat. No. 8,286,875 to Tang et al (2012) further expand on other devices that can transmit credit card informations via the audio jack of a communication device such as “a bar code reader, a magnetic stripe reader, an integrated circuit reader, a smart card reader, a fingerprint scanner, an optical scanner, a signature pad, an alphanumeric keypad (including a PIN pad), a proximity detector, an audio recording device, a camera or combinations thereof and the like.” These patents also describe a method in which the credit card information can be sent to a server to process the transaction.

Merchants who have built their own mobile application (app) can implement the methods described above in which a customer can swipe a credit card (or connect a card and enter the pin) as payment with a card reader. The payment information can be sent to the merchant server and further relayed to their payment processor. These methods would allow the merchant to receive card-present rates but the data would reach their servers and so they fall within PCI scope. For those merchants who do not have a mobile app could decide to build their own. But for others, a mobile app could be an expensive and unwanted undertaking.

Some third-party merchant aggregator services, such as PayPal® Here and Square®, offer their own mobile applications and card readers to allow merchants to accept credit card payments with a mobile device. These services are geared toward brick-and-mortar merchants and not focused on e-commerce. Similar to Braintree® and Stripe®, these aggregators use their own payment processors and are expensive at scale for larger merchants.

What is needed is a method to enable merchants to avoid PCI scope and accept card-present payments for e-commerce while still receiving the preferred rates they negotiated with their chosen payment processor.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates to systems and methods for receiving card-present payments for e-commerce orders on behalf of merchants.

In an aspect, the invention features a method including, in a network comprising at least a mobile device, a merchant's server, a merchant's payment processor and a third party server, the mobile device including a merchant's mobile app, the merchant's mobile app including a third party integrated software development kit (SDK), the mobile device linked to a card reader, accepting card-present payment using the third party SDK provided by a third-party partner within merchant's mobile app.

In another aspect, the invention features a method including, in a network comprising at least a mobile device, a merchant's server, a merchant's payment processor and a third party server, the mobile device including a merchant's mobile app, the merchant's mobile app including a third party integrated software development kit (SDK), the mobile device linked to a card reader, and a push notification service positioned between the mobile device and the merchant's server, accepting card-present payment for orders that originate through a browser from a merchant's e-commerce website.

In another aspect, the invention features a method including, in a network comprising at least a mobile device, a merchant's server, a merchant's payment processor and a third party server, the mobile device including a merchant's mobile app, the merchant's mobile app including a third party mobile app, the mobile device linked to a card reader, and a push notification service positioned between the mobile device and the merchant's server, accepting card-present payment for orders that originate through a browser from a merchant's e-commerce website, receiving card-present payment from an order that originates from a merchant's e-commerce website on a browser.

In another aspect, the invention features a method including, in a network comprising at a mobile device, a merchant's server, a merchant's payment processor and a third party server, the mobile device including a third party mobile app and a merchant's mobile app, the mobile device linked to a card reader, and a push notification service positioned between the mobile device and the merchant's server, receiving card-present payment within the merchant's mobile app without an integrated software development kit (SDK).

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following FIGs., wherein:

FIG. 1 is a block diagram of an exemplary network including an integrated third-party software development kit (SDK) within a merchant's mobile application.

FIG. 2 is a block diagram of an exemplary network including offline to online checkout with integrated third-party SDK within a merchant's mobile application.

FIG. 3 is a block diagram of an exemplary network including offline to online checkout with a third-party mobile application.

FIG. 4 is a block diagram of an exemplary network including a third-party mobile application in conjunction with a merchant's mobile application.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

In the description below, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

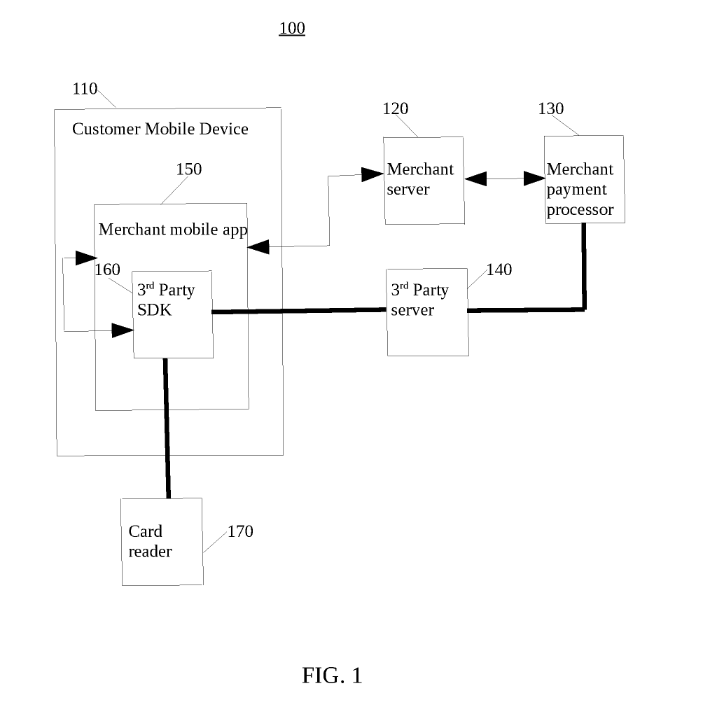

The systems shown in FIGS. 1-4 are used to host methods of receiving card-present payment for e-commerce orders on behalf of merchants. In the figures, the thick lines represent channels that may carry sensitive card data. These methods illustrate how a merchant can avoid the liability associated with handling sensitive card data while still receiving preferred card-present rates.

As shown in FIG. 1, in a preferred embodiment, an exemplary network 100 includes a mobile device 110, a merchant's server 120. a merchant's payment processor 130 and a third party server 140. The mobile device 110 includes a merchant's mobile app 150, which in turn includes a third party integrated software development kit (SDK) 160. The mobile device 110 is shown linked to a card reader 170. The network 100 provides a method for a merchant to accept card-present payment using the third party SDK 160 provided by a third-party partner within their own mobile application app.

In FIG. 1, a payment flow begins with an order that has originated within the merchant's native (Android®, iOS®, and so forth) mobile app 150 in the customer's mobile device 110. When the order is complete, the customer is directed to a payment page of the merchant's mobile app 150 and the integrated SDK 160 is initiated. The SDK 160 manages a checkout flow and is responsible for accepting credit card payment information from the card reader 170 connected to the mobile device 110. The SDK 160 provides callback methods so the merchant's mobile app 150 can provide visual feedback to the customer. These methods include, but are not limited to, notifications such as “Card reader has been connected” and “There was an error reading the card. Please swipe again”.

The SDK 160 also provides the mobile application 150 with minimal credit card data, such as, for example, card type (Visa®, Mastercard®, American Express®, and so forth) and the last 4 digits of the credit card's account number. When the credit card information has been provided by the customer, the merchant 120 provides the proper authorization credentials and total amount to the third-party server 140 to process the transaction. The transaction request is sent to the third-party server 140 over the Internet. The third-party server 140 can do further processing with the card data if needed before forwarding the credit card information to the merchant's payment processor 130 to authorize the payment. A successful authorization response from the payment processor 130 is then passed on from the third-party server 140 to the SDK 160 and back to the mobile application 150 to complete the payment flow.

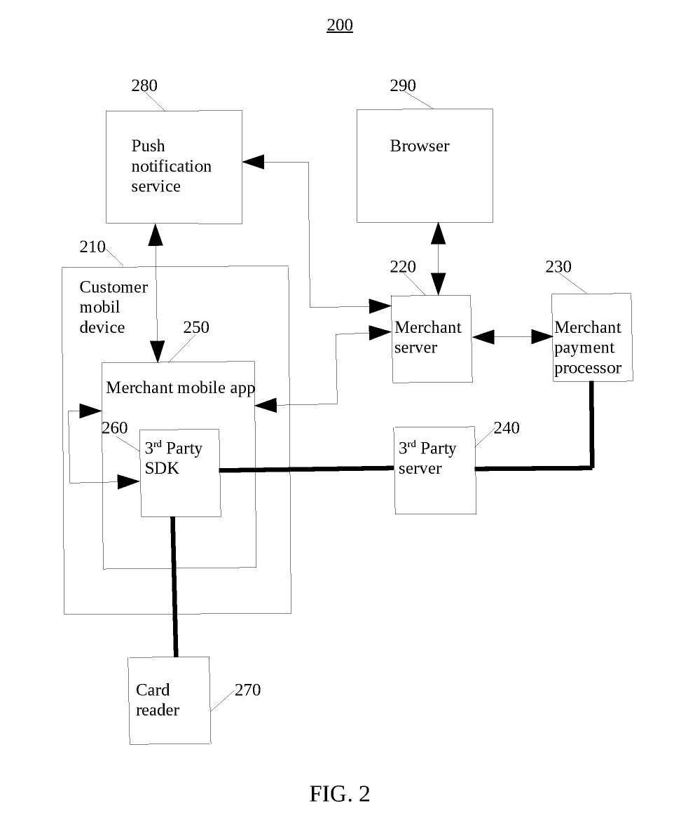

As shown in FIG. 2, an exemplary network 200 includes a mobile device 210, a merchant's server 220, a merchant's payment processor 230 and a third party server 240. The mobile device 210 includes a merchant's mobile app 250, which in turn includes a third party integrated software development kit (SDK) 260. The mobile device 210 is shown linked to a card reader 270. The network 200 also includes a push notification service 280 positioned between the mobile device 210 and the merchant's server 220.

Network 200 provides a platform for a method for a merchant to accept card-present payment for orders that originate through a browser from the merchant's e-commerce website on a desktop computer, a laptop, a tablet, a mobile device or any other similar device 290. When an order is complete, a push notification is sent from the merchant's server 220 to the authorized customer's mobile device 210 and is received by the merchant's mobile app 250. Note that this mobile device 210 could be the same device used to place the order. The mobile app 250 alerts and directs the customer to the payment page within the mobile app 250. From here, the integrated SDK 260 within the mobile app 250 facilitates payment as described in FIG. 1.

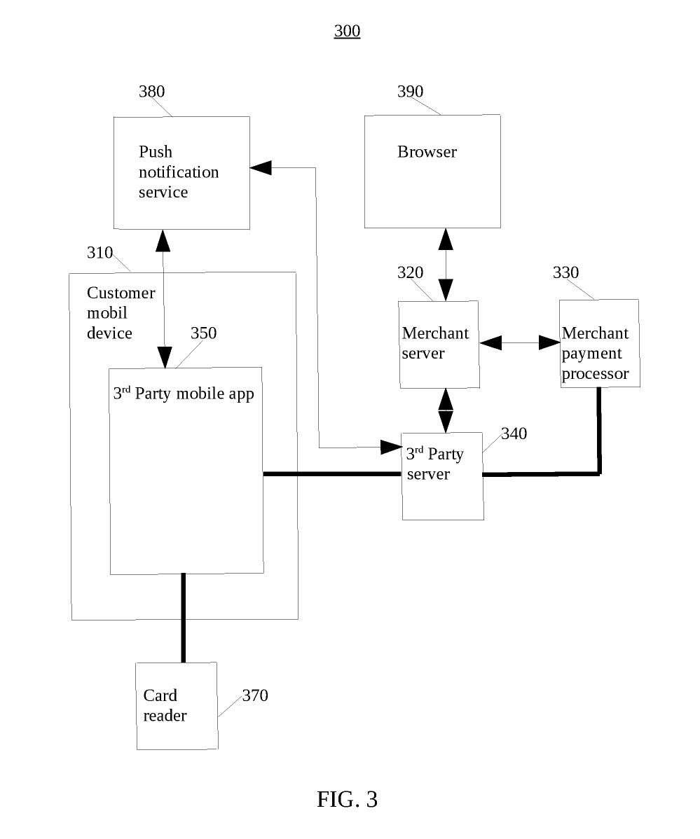

As shown in FIG. 3, an exemplary network 300 includes a mobile device 310, a merchant's server 320, a merchant's payment processor 330 and a third party server 340. The mobile device 310 includes a third party mobile app 350. The mobile device 310 is shown linked to a card reader 370. The network 300 also includes a push notification service 380 positioned between the mobile device 310 and the merchant's server 320.

Network 300 provides a platform for a method for a merchant to receive card-present payment without its own mobile app form, an order that originates from the merchant's e-commerce website on a browser 390. The merchant's server 320 connects to the third-party's server 340, using, for example, the OAuth protocol, to access the customer's third-party credentials. “OAuth” is an open protocol to allow secure authorization in a simple and standard method from web, mobile and desktop applications. Once these credentials are received, the merchant's server 320 sends the order details to the third-party's server 340 using the customer's authorization credentials. This request will also contain a WebHook callback Uniform Resource Locator (URL) to asynchronously receive a successful authorization response. In general, a “WebHook” is an HTTP callback: an HTTP POST that occurs when something happens; a simple event-notification via HTTP POST.

Once the third-party server 340 receives the payment request, a push notification is sent to the authorized customer's mobile device. The third-party mobile app within the customer's mobile device receives the push notification 380 and the customer provides the credit card information with the connected card reader 370. The credit card information is sent to the third-party's server 340 and then forwarded to the merchant's payment processor 330. A successful response is asynchronously sent to the merchant's WebHook callback URL to complete the payment flow.

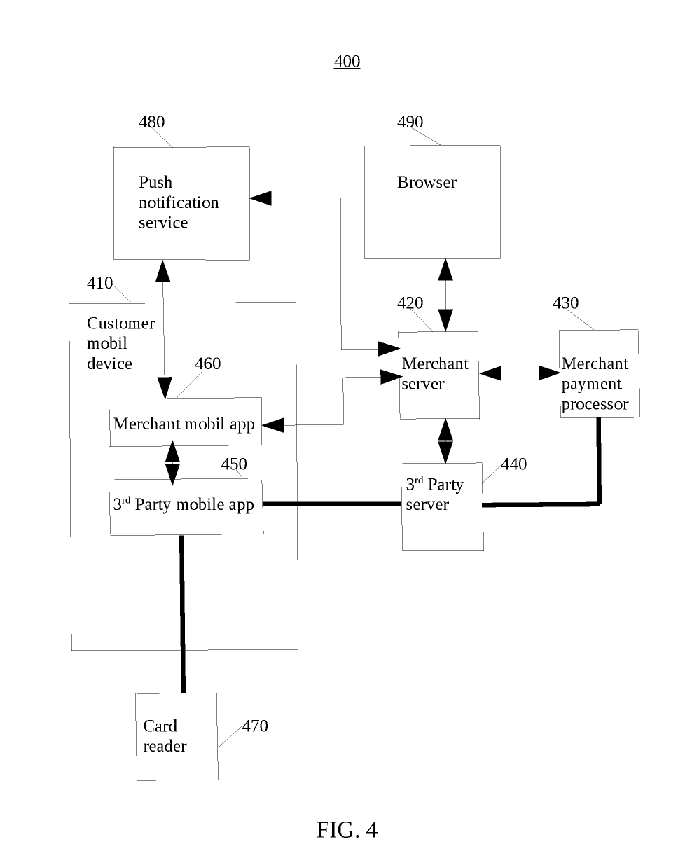

As shown in FIG. 4, a network 400 includes a mobile device 410, a merchant's server 420, a merchant's payment processor 430 and a third party server 440. The mobile device 410 includes a third party mobile app 450 and a merchant's mobile app 460. The mobile device 410 is shown linked to a card reader 470. The network 400 also includes a push notification service 480 positioned between the mobile device 410 and the merchant's server 420.

Network 400 provides a platform for a method for a merchant to receive card-present payment within its own mobile app without an integrated SDK. The order can originate in a browser 490 or within the merchant's mobile app 460. If the order originates in a browser 490, a push notification 480 can be sent to the authorized customer's mobile device similar to the one used in FIG. 2 to direct the customer to the payment page. If the order originates in the mobile app 460, the customer is directed immediately to the payment page.

When the customer provides payment information at the payment page of the mobile app 460, the merchant mobile app 460 sends an authorized request to the third-party mobile app 450 in the customer's mobile device 410. In Android®, such a request can be done using intents and in iOS® the request can be done with a well-defined URL schema or with App extensions. The third-party mobile app 450 takes over the payment flow like in FIG. 3. When the third-party mobile app 450 receives a successful authorization response, the response is forward back to the merchant mobile app 460 using the callback methods designed within the mobile device's software (Android®, iOS®, and so forth) and returns an asynchronous response to the merchant's mobile app 460.

### Example Operation

In operation, all requests made between a merchant e-commerce site, merchant mobile app, the third-party server and the third-party mobile app are securely sent and properly encrypted. Any requests conducted over the Internet are sent over a secure connection, such as HTTPS. During the on-boarding process, the third-party provides the merchant with public and secret API keys to authorize requests and to securely encrypt payloads. The unique public API key is used to properly identify the merchant to the third-party and is sent with each request. The secret key is kept private and is only known to the merchant and the third party. Also during the on-boarding process, the merchant provides the third-party with their payment processor credentials. The third-party can then send requests to the payment processor on behalf of the merchant.

All payloads, which include the merchant order number, total amount and encrypted credit card information, are encrypted using the secret key and a keyed-hash message authentication code (HMAC) to ensure data integrity and proper authorization and authentication.

For the methods described in FIGS. 2 and 4, the merchant maintains a unique device ID for the customer's mobile device in order to send push notifications from the e-commerce site to the merchant's mobile app within the device. For Android®, the merchant saves the device's registration ID and for iOS®, the device token.

For methods described in FIGS. 3 and 4, the third-party provides its own native mobile application that can communicate with the external card reader connected to the customer's mobile device. These methods require that the customer register for a separate account with the third-party and also downloads the mobile app to their device. The third-party stores and manages the unique device id for the customer's mobile device on its server. In these methods, the merchant uses its public and secret API keys to properly authenticate and encrypt payloads. This encryption ensures that no rogue applications within the customer's mobile device are able to intercept the payload and decipher it.

The method described above in FIG. 3 also requires third-party authorization from the customer. In this method, the merchant does not have its own mobile app and requires the third-party mobile app to accept payment. In this case, an authorization process, such as OAuth, enables the merchant to send a request on behalf of the customer so that a push notification can be sent to the customer's mobile device. Using the OAuth protocol on the customer's browser, the merchant directs the customer to the third-party's OAuth sign-in page. The customer signs in using his third-party login credentials to grant a one-time access token for the merchant.

The customer is then redirected back to the merchant's website using an OAuth WebHook callback with the access token in the payload. The merchant then sends a request to the third-party using the one-time use access token. The third-party can then send a push notification to the customer's mobile device to initiate the payment flow.

For methods described in FIGS. 1, 2 and 4, all authorization responses from the merchant's payment processor can be synchronously sent back to the merchant's mobile app. From there, the merchant can then fulfill the order. The method described in FIG. 3, however, requires an asynchronous response.

After a successful OAuth authentication, a payment request is made to the third-party server. The third-party sends an acknowledgment response synchronously. The merchant can then mark the order as payment pending on its server. Once payment has been received from the customer's mobile device and has been authorized by the payment processor, the third-party sends a successful authorization notification to the merchant's server that the merchant can verify with a subsequent request to the third-party server. Once verified, the order is marked as paid and then fulfilled.

These methods enable the merchants to accept payment for e-commerce orders at card-present rates. This fee is generally lower than that of card-not-present transactions because of lower risk of potential fraud. Implementing these methods enables credit card payment to flow through a third-party vendor ensuring that sensitive customer data never reaches the merchant's servers. This fact would eliminate PCI requirements and the high cost of protecting customer data from potential hackers

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

What is claimed is:

1. A method comprising:
in a network comprising at least a mobile device, a merchant's server, a merchant's payment processor and a third party server, the mobile device including a merchant's mobile app, the merchant's mobile app including a third party integrated software development kit (SDK), the mobile device linked to a card reader, accepting card-present payment using the third party SDK provided by a third-party partner within merchant's mobile app.

2. The method of claim 2 wherein accepting card-present payment comprises:
receiving notification of an order originated in the merchant's mobile app in the customer's mobile device;
directing the customer to a page of the merchant's mobile app; and
initiating the integrated SDK.

3. The method of claim 2 wherein the initiating the integrated SDK comprises:
managing a checkout flow;
accepting credit card payment information from the card reader;
providing callback methods so the merchant's mobile app can provide visual feedback to the customer; and
providing the mobile application with minimal credit card data and the last four digits of a credit card's account number.

4. The method of claim 3 further comprising:
providing proper authorization credentials and a total amount to the third-party server to process the transaction;
sending the transaction to the third-party server over the Internet;
forwarding, from the third-party server, the credit card information to the merchant's payment processor to authorize the payment.

5. The method of claim 4 further comprising:
passing a successful authorization response from the payment processor from the third-party server to the SDK and back to the mobile application to complete a payment flow.

6. A method comprising:
in a network comprising at least a mobile device, a merchant's server, a merchant's payment processor and a third party server, the mobile device including a merchant's mobile app, the merchant's mobile app including a third party integrated software development kit (SDK), the mobile device linked to a card reader, and a push notification service positioned between the mobile device and the merchant's server, accepting card-present payment for orders that originate through a browser from a merchant's e-commerce website.

7. The method of claim 6 wherein accepting card-present payment for orders comprises:
receiving an order;
sending a push notification from the merchant's server to the merchant's mobile app in the customer's mobile device;
alerting and directing, from the merchant's mobile app, the customer to the payment page within the mobile app.

8. The method of claim 7 further comprising initiating the integrated SDK.

9. The method of claim 8 wherein initiating the integrated SDK comprises:
managing a checkout flow;
accepting credit card payment information from the card reader;
providing callback methods so the merchant's mobile app can provide visual feedback to the customer; and
providing the mobile application with minimal credit card data and the last four digits of a credit card's account number.

10. The method of claim 9 further comprising:
providing proper authorization credentials and a total amount to the third-party server to process the transaction;
sending the transaction to the third-party server over the Internet;
forwarding, from the third-party server, the credit card information to the merchant's payment processor to authorize the payment.

11. The method of claim 10 further comprising:
passing a successful authorization response from the payment processor from the third-party server to the SDK and back to the mobile application to complete a payment flow.

12. A method comprising:
in a network comprising at least a mobile device, a merchant's server, a merchant's payment processor and a third party server, the mobile device including a merchant's mobile app, the merchant's mobile app including a third party mobile app, the mobile device linked to a card reader, and a push notification service positioned between the mobile device and the merchant's server, accepting card-present payment for orders that originate through a browser from a merchant's e-commerce website, receiving card-present payment from an order that originates from a merchant's e-commerce website on a browser.

13. The method of claim 12 wherein receiving card-present payment comprises:
connecting the merchant's server to the third-party's server to access the customer's third-party credentials.
sending the order details from the merchant's server 320 to the third-party's server 340 using the customer's authorization credentials.
sending a push notification from the third-party server to the authorized customer's mobile device; and
providing credit card information with the connected card reader.

14. The method of claim 13 further comprising:
sending the credit card information to the third-party's server; and
forwarding the credit card information to the merchant's payment processor.

15. A method comprising:
in a network comprising at a mobile device, a merchant's server, a merchant's payment processor and a third party server, the mobile device including a third party mobile app and a merchant's mobile app, the mobile device linked to a card reader, and a push notification service positioned between the mobile device and the merchant's server, receiving card-present payment within the merchant's mobile app without an integrated software development kit (SDK).

16. The method of claim 15 wherein receiving card-present payment comprises:
receiving an order;
directing a customer to a payment page.

17. The method of claim 16 further comprising:
sending, from the merchant mobile app, an authorized request to the third-party mobile app in the customer's mobile device once the customer provide payment information at the payment page of the mobile app.

18. The method of claim 17 further comprising:
processing payment in the third-party mobile app.
